(19) United States
(12) Patent Application Publication
(10) Pub. No.: US 2002/0065797 A1
(43) Pub. Date: May 30, 2002

(54) System, method and computer program for automated collaborative filtering of user data

(75) Inventors: Abraham Meidan, Tel Aviv (IL); Hadas Ravid, Ramat Hasharon (IL); Zbeida Oren, Givataim (IL)

Correspondence Address: DR. MARK FRIEDMAN LTD, C/O BILL POLKINGHORN- DISCOVERY DISPATCH, 9003 FLORIN WAY, UPPER MARLBORO, MD, 20772, US

(73) Assignee: WIZSOFT LTD.

(21) Appl. No.: 09/726,046

(22) Filed: Nov. 30, 2000

(51) Int. Cl. G06F 7/00

(52) U.S. Cl. 707/1

(57) ABSTRACT

A system and method for collaborative filtering of data, such that accurate real time recommendations can be provided to users, without prior rating by users. The invention's main purpose is to discover the purchasing patterns of the users (customers) of a particular vendor (this includes stores or other points of sale, such as service businesses), whether they are virtual places on the Internet or conventional offline places.

The present invention operates in two stages: In the preliminary stage the system reads the previous sales transactions, and makes various queries on previously collected user data, deriving rules. In the second phase, a user making a new request sends the request to the software component, where it is processed in relation to the rules. The result of this processing is a derivation of predictions and alerts concerning the users' information or purchase requests. The system also checks user baskets in order to predict if there are preferred items that have not been included, or determine whether there are unexpected items that may indicate buying mistakes or security warnings.

The best modes of the invention are for use in online virtual stores and offline conventional stores. Such stores may be shops, vendors or service providers.

### FIELD AND BACKGROUND OF THE INVENTION

The present invention relates to a system and method for collaborative filtering of data, in order to provide real time recommendations and alerts to users.

The field of collaborative filtering has expanded significantly since the popularization of the Internet. The knowledge base of products and services has continued to grow at an ever-increasing rate, in regular stores and businesses, as well as online. The Internet, for example, offers consumers the ability to virtually browse millions of products, each with their features and reviews. Therefore many means have been developed to analyze, filter and streamline this data so that consumers can be given tools to ease the burden of massive choices. Among these means are various means of filtering data, and especially the use of collaborative filtering. Collaborative filtering systems can produce personal recommendations by computing the similarity between a user's preferences and the preferences of other users. This function attempts to automate the process of “word-of-mouth” by which people recommend products or services to one another.

Collaborative filtering is currently used by various online sites that analyze user actions for the sake of providing purchasing recommendations, as a value added service for users, and a promotion tool for vendors. There are several known products for recommending items. One of the most popular applications of collaborative filtering can be found in the Internet shop Amazon.com. In this case, Amazon collects data of users, such as which pages were visited, which links were clicked and which products were bought. They aggregate and filter this mass of data, and finally present it to fellow users when the users access pages that were previously accessed. The information is passed on to the user in the form of extra information on a relevant page.

There are several patents in regard to methods for collaborative filtering. U.S. Pat. Nos. 5,790,426, 5,867,799 and 6,092,049 present methods and apparatus for recommending items on the basis of ratings given to an item by the user. Obviously such a rating is time consuming and might be subjective and therefore not accurate. U.S. Pat. No. 5,704,017 presents a collaborative method that is based on belief network. However implementing this belief network requires an expert that enters the prior knowledge.

There is thus a widely recognized need for, and it would be highly advantageous to have, a system and method for collaborative filtering that can be automatically expanded and easily monitored, and that can operate in shopping baskets, without the need for prior user ratings. There is a further need for such an invention to be simple to use by the end-user, that it offers improved accuracy, and that it not only offers recommendations, but also alerts in cases of two (different) items that are likely not to be in the same basket.

The present invention answers the above mentioned needs. It is innovative in that it is implemented automatically by a new computerized means. This is in contrast to alternative available methods for collaborative filtering that typically require regular expert intervention. In addition, the present invention presents recommendations that are not identical to the recommendations issued by the other methods, and therefore using the present invention together with other methods can raise the number and accuracy of recommended items.

The invention is non-obvious in that it is based on a new algorithm that cannot be derived from the known approaches. This new means, including a new algorithm, enables the automatic filtering of user data on both individual item and multi-item levels. Furthermore, the present invention can be used to issue alerts for the purpose of circumventing purchasing mistakes and theft.

There is no known patent for executing collaborative filtering without prior ranking, where all this is done in an entirely automatic way. Therefore the recommendations provided to users of the present invention are dissimilar to those based on existing products. The following are factors that distinguish the present invention from existing technologies.

(1) The present invention is based on a new algorithm for revealing the patterns, which is substantially different from the algorithms used by the known programs.

(2) The present invention is more easily implemented than the other known algorithms. This is owing to the fact that the algorithm of the present invention can be implemented automatically, while implementing the other algorithms should be done by experts.

(3) None of the known algorithms reveal patterns of unexpected baskets (see cases #2 and #4 below).

### SUMMARY OF THE INVENTION

According to the present invention there is provided a system and method for Collaborative filtering of data so as to provide real time purchase, information recommendations and alerts to users. This is provided in a fully automatic way, without the need for prior rating by users.

The present invention operates in two stages: In the preliminary stage the system reads and analyses the sales/previous transactions from stored transactions from previous users or the current user. This may include information requests, even if they weren't actual transactions. For example, for an online store, (assuming there is a table containing the items purchased in each sale), the following queries are issued and saved in the data: (1) For each item, what is the overall frequency of the item in the baskets? (2) For each item and customer, what is the overall frequency of the item in the customer's baskets? (3) For each pair of items, A and B, what is the frequency of item B in baskets containing item A? (4) For each customer, C, and pair of items, A and B, what is the frequency of item B in the customer's baskets containing item A? In the second stage, when an unknown customer inserts an item to the basket, the system recommends, on the basis of (1) and (3) items having frequency higher than the overall frequency. And when a returning customer inserts an item to the basket the system recommends, on the basis of (2) and (4), additional items having frequency higher than the frequency in the customer's baskets. When the basket includes several items, the system also checks if the basket contains two relatively frequent items that are usually not included in the same basket (among all the baskets or among the customer's previous baskets).

The best mode of the present invention is an online or offline vendor, where customer requests are entered directly into a computer system, and where prior user request or purchase information is stored in a database on the same computer system. In this way the user requests can be processed and integrated with prior user information, such that recommendations or alerts can be applied in real time.

### BRIEF DESCRIPTION OF THE DRAWING

FIG. 1: Illustrates the collaborative filtering according to the present invention.

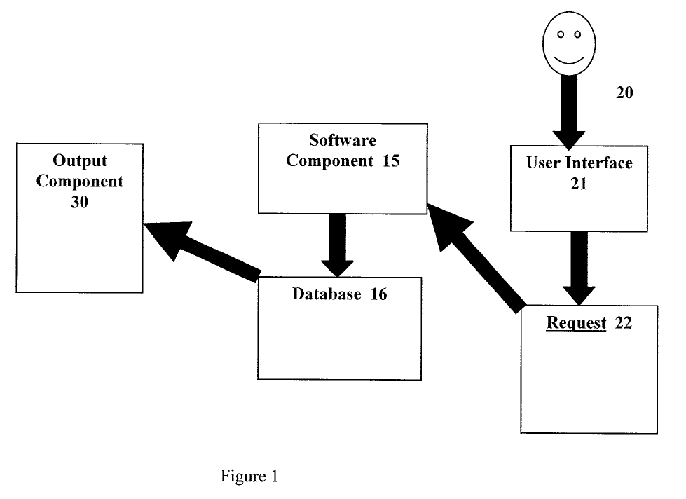

### DESCRIPTION OF THE PREFERRED EMBODIMENT

The present invention is of a system and method for collaborative filtering.

Specifically, the present invention can be used to automatically filter user data from sales, in order to offer recommendations based on previous user activity.

The invention's main purpose is to discover the purchasing patterns of the users (customers) of a particular shop (this includes stores or other points of sale such as service businesses, both virtual places on the internet or “old-fashioned/offline places), and on the basis of these patterns:

(1) To recommend items that the customer will probably like to add to his/her basket; and

(2) To reveal baskets deviating from the patterns, in order to alert the customer, and/or detect cases of fraud.

The principles and operations of such a system according to the present invention may be better understood with reference to the following figure and accompanying description, wherein:

Referring to the Figure, the system is comprised of the following steps:

i. The software component of the present invention 15 analyses prior user requests or transactions from a database 16 maintained by the particular vendor or service provider.

ii. The software component derives rules based on statistical frequencies of various requests. The rules derived from this analysis are stored in the database 16.

iii. When a user 20 enters the system through a user interface 21 (such as an online vendor checkout page or a physical shop checkout counter) the user 20 makes an information or purchase request 22, which is transferred to the software component 15 (this component may be situated on a local computer station or a Web page server).

iv. The software component 15 processes the current user requests 22 against the previously derived rules, applying the saved rules.

v. The results of this query are presented to the user (customer, security sources or cashier etc.) in the form of alerts, recommendations or useful information. Theses alerts or recommendations are presented to the user via the output component 30, which may be a graphic user interface (such as a Web browser, smart phone browser etc.), a textual interface (such as email software, SMS software, WAP browsers etc.), or any other interface where the recommendations may be displayed.

The present invention relies on external information sources, such as Vendor databases containing sales records or Web site usage statistics databases. For each sale at a vendor store, for example, the database usually contains some details about the customer (such as the customer account number, or the customer credit card number) and the list of items bought (the basket). On the basis of this, database can search patterns such as:

1. When the basket contains item A, there is a relatively high probability that it also contains item B.

2. When the basket contains item A, there is a relatively high probability that it does not contain item C.

3. If the customer is D, and the basket contains item A, there is a relatively high probability that it also contains item E.

4. If the customer is D, and the basket contains item A, there is a relatively high probability that it does not contain item F.

On the basis of these patterns the shop can check the customer baskets, either when the customer adds an item to the basket in a virtual shop, or when the customer places an order or brings the items to the point-of-sale in a regular shop. The vendor computer system can then apply the discovered patterns to the customer basket and suggest additional items or alert the shop or user to cases of suspected mistakes or fraud. For example, if the customer is D, and his/her basket contains item A but not item E, then on the basis of pattern #3, the shop can recommend considering item D. And if the basket contains both item A and item C, the shop can alert the user or security sources that this combination is unexpected.

When accessing the sale database, it is assumed that the database contains the following information for each sale: At least one field uniquely identifying the customers, and one or more field(s) uniquely identifying the item(s) bought. Usually the sale database is built by another application.

The following are examples of queries that may be issued: (Calculations of such queries may be executed by conventional statistical software programs)

i. For each item, A, what is the relative frequency of the baskets containing this item out of all the baskets? This may be designated by P(A).

ii. For each item A and customer C, what is the relative frequency of baskets containing this item out of all the customer's baskets? This may be designated by Pc(A).

iii. For each pair of items, A and B, what is the relative frequency of baskets containing item B out of all the baskets containing item A. The output of this query is a rule having the following structure: If a basket contains item A, then there is a P probability that it contains item B as well. This may be designated by P(A>B). Saving the rules where the difference between P(A>B) and P(B) is above a predefined threshold, which is defined as a recommendation rule, or below another threshold, which is defined as an alerting rule.

iv. For each pair of items, A and B, and for each customer, C, what is the relative frequency of baskets containing items B out of all the baskets belonging to the customer C and containing item A. The output of this query rule having the following structure: If a basket belongs to the customer C and contains item A, then there is a P probability that it contains item B as well. This may be designated by Pc (A>B). Saving the rules where the difference between Pc (A>B) and P(B) is above a predefined threshold as a recommendation rule, and saving the rules where this difference is below another threshold as an alert rule. The threshold should be defined as a function of each item's frequencies and the rule probability.

v. Applying the saved rules to items to the customer's basket: If the customer is anonymous, the rules that were saved in stage (2.3) can be applied. If the customer is identified as an old customer, the rules saved in stage (2.4) that refer to this customer can be applied. If a recommendation rule is applied, the recommended item can be listed, and if an alert rule is applied, an alert can be displayed. The rule can be applied after each item added to the basket and/or before issuing the invoice (or order or delivery note).

### EXAMPLES OF THE SYSTEM ARE AS FOLLOWS

### Example 1

The data is a grocery sale database. Coffee in included in 5% of the baskets, sugar in included in 6% of baskets. In 80% of the baskets containing coffee, sugar is also included. The rule is applied to a new basket containing coffee without sugar. The system recommends adding sugar to the basket.

### Example 2

The data is the same database mentioned above. Coffee is included in 10% of Mr. X's baskets, and saccharine in another 10%. In 70% of Mr. X's baskets containing Coffee, saccharine is also included. The rule is applied to a new basket of Mr. X containing coffee without saccharine. The system recommends adding saccharine to the basket.

### Example 3

The data is the same database mentioned before. Diet Coke is included in 30% of the baskets, and Regular Coke is included in 40% of the baskets, but only 1% of the baskets contain both Diet and Regular Coke. The rule is applied to a new basket containing both products, and an alert message is displayed.

The best mode of the invention is as a software program embedded in an application for sales either in an Internet based shop/point of sale, or in a “conventional” shop/business.

The present invention might also be implemented in an independent software program or in any other interactive form, so as to provide recommendations or alerts in any other contexts where these are relevant. Examples include professional services, B2B commerce and G2C (Government to Consumer) commerce.

While the invention has been described with respect to a limited number of embodiments, it will be appreciated by someone ordinarily skilled in the art that many variations, modifications and other applications of the invention may be made.

What is claimed is:

1. A method for processing a recommendation for a user, according to collaborative filtering rules, comprising the steps of:
i) For each item (A), querying relative frequency of said item out of all baskets (this frequency will designated later by: F(A));
ii) For each said item, A, and customer, C, querying relative frequency of said item out of baskets of said customer, (this frequency will be designated later by: Fc(A));
iii) For each pair of items, A and B, querying relative frequency of baskets containing said item A out of baskets containing both item A and B, (this frequency will be designated later by: F(A&B)); and establishing a rule that if a basket contains item B but not item A, recommend item A, in the case where a difference between F(A&B) and F(A) is above a predetermined threshold; and
iv) For each pair of items, A and B, and a customer, C, querying the relative frequency of said baskets containing item A out of said baskets of customer C containing item A and item B, (this frequency will designated later by: Fc(A&B)); and establishing a rule that if a basket belongs to customer C and contains item B but not item A, recommend item A, in the case where a difference between Fc(A&B) and Fc(A) is above a predetermined threshold.

2. The method of claim 1, wherein step (iii) further includes establishing a rule that if a basket contains item A and B, alert that item A should not be in said basket, in the case where a difference between F(A) and F(A&B) is above a predetermined threshold.

3. The method of step 1, wherein step (iv) further includes establishing a rule that if a basket belongs to customer C and contains item A and B, alert that item A should not be in said basket”, if the difference between Fc(A) and Fc(A&B) is above a predetermined threshold.

4. The method of claim 1, wherein the processing of the recommendation for said user further includes the steps of:
v) If said customer is anonymous, applying said rules of claim 1c, such that a recommendation is created for said customer,
vi) If said customer is an old customer applying said rules in claim 1d, such that a recommendation is created for said customer,

5. The method of claim 1, wherein said basket includes data selected from the group consisting of purchase requests, information requests, security requests and sales requests.
